(19) United States
(12) Patent Application Publication
(10) Pub. No.: US 2004/0010093 A1
(43) Pub. Date: Jan. 15, 2004

(54) UV-resistant flocking adhesive for polymeric substrates

(76) Inventors: Rainer Wefringhaus, Hilden (DE); Richard Hemel, Monheim (DE)

Correspondence Address: Stephen D. Harper, Law Department, Suite 200, 2500 Renaissance Blvd., Gulph Mills, PA, 19406, US

(21) Appl. No.: 10/435,302

(22) Filed: May 9, 2003

Related U.S. Application Data
(63) Continuation of application No. PCT/EP01/12634, filed on Oct. 31, 2001.

(30) Foreign Application Priority Data
Nov. 9, 2000 (DE) DE 100 55 559.4

(51) Int. Cl. C08F 283/00

(52) U.S. Cl. 525/418; 525/452

(57) ABSTRACT

Two-component polyurethane binding agents based on a polyester polyol with an aliphatic or cycloaliphatic polyisocyanate and a curing-agent component based on polyamine mixtures are suitable as UV-resistant flocking adhesives for the flocking of polymeric substrates. These adhesives can be processed in accordance with all standard processing techniques and result in flocked articles with high UV resistance and good abrasion resistance.

This application is a continuation under 35 USC Sections 365(c) and 120 of International Application No. PCT/EP01/12634, filed Oct. 31, 2001, which claims priority from German Application No. DE 10055559.4, filed Nov. 9, 2000.

### BACKGROUND OF THE INVENTION

1. Field of the Invention

The invention relates to UV-resistant flocking adhesives for polymeric substrates, based on 2-component polyurethane binding agents, to a process for producing flocked articles and also to flocked articles based on an elastomer.

2. Discussion of the Related Art

The surface finishing of the most varied substrates, such as textiles, leather, paper, plastics etc, by flocking is widespread. In this process the substrate to be finished is firstly coated with an adhesive, into which fibrous particles are then introduced, in particular injected electrostatically. As a result of subsequent drying and curing of the adhesive, the fibers are firmly anchored on the surface of the substrate; the properties and the durability of the finished surfaces depend both on the fibrous particles that are used and on the so-called flock adhesive. The electrostatically flocked objects that are produced in this way are distinguished by a textile-type surface and by distinctly lower friction, e.g. in relation to glass. One of the numerous applications of such flocked products, in particular of flocked polymeric substrates such as vulcanized and non-vulcanized elastomers, is their incorporation into window channels of automobiles as a sealing collar or gasket.

The quality characteristics with respect to durability and usability of such flocked, mechanically stressed parts also depend very much on the flock adhesive that is employed. The basic prerequisite is acknowledged to be that the adhesive has to develop a good adhesion both to the carrier material and to the flock fiber. In addition, high dry strengths and wet abrasion strengths, as well as, in particular, high resistances to ageing and UV radiation as well as good resistances to water, washing and cleaning agents, oils, fats, organic solvents and so on are demanded. Furthermore, the flock adhesives must be easy to handle and capable of being processed simply and without difficulty. In particular in the automotive industry, polymeric substrates, in particular elastomers such as styrene-butadiene synthetic rubbers, chloroprene rubbers or, very frequently, ethylene-propylenediene copolymers (EPDM rubbers), are employed as carrier materials to be flocked. For the flocking of such materials, chloroprene rubber is employed by way of adhesive, for example dissolved in organic solvents. However, such adhesives exhibit only very limited UV resistance. DE-A-31 45 861 describes a solution of a non-reactive polyurethane prepolymer in a solvent for the same purpose.

DE-A-35 08 995 describes a triethanolamine-modified polyurethane adhesive for the electrostatic flocking of fibrous material on rubber, plastic or metal. Clothing, shoes, towels, furniture, electrical appliances and channel structures for automobiles are stated as the field of application for the flocked materials. The polyurethanes are synthesised from polyether polyols, polyester polyols and aromatic diisocyanates. Although it is stated that these flocked articles are suitable for use in the outdoor domain, their UV resistance is in need of improvement.

EP-A-129 808 describes a flocking adhesive for flexible substrates. This adhesive is intended to be suitable, in particular, for the flocking of non-polar elastomers such as EPDM. The adhesive consists of a polyurethane prepolymer with isocyanate end groups, which is dissolved or dispersed in organic solvents. It contains by way of adhesion promoter a conversion product of aromatic diisocyanates with polyfunctional epoxides, in particular triglycidyl isocyanurate. It is further proposed, with a view to improving the adhesive strength, to add aromatic nitroso compounds where appropriate. Whereas, according to the disclosure of this publication, the use of these adhesives brings about a high abrasive resistance of the flock, nothing is stated about the UV resistance of the flocked materials.

EP-A-304 675 discloses moisture-curing flocking adhesives for polymeric substrates, based on conversion products which are formed from diisocyanates with mixtures of difunctional polyols with an NCO:OH molar ratio from 6:1 to 8:1 and with a viscosity in the range from 600 to 900 mPa.s at 20° C. These flocking adhesives further contain 1 to 5 parts by weight of aromatic dinitroso compounds and 3 to 10 parts by weight of hydroxyl-group-free epoxy resins with epoxide values from 0.45 to 0.75 as well as, optionally, up to 20 parts by weight of C8-C18 alkylbenzenes. These flocking-adhesive compositions are intended to exhibit improved stability in storage as well as improved resistance to water. Nothing is stated about the UV resistance of these flocking adhesives or of the flocked objects that are produced with them.

The polyurethane flocking adhesives pertaining to the state of the art which are based on polypropylene glycols and aromatic diisocyanates are not suitable at all for light-resistant flockings. Test rows of these films are already totally destroyed in the xenon test after 100 hours; they are therefore not suitable for externally situated, in particular colored, flocked profiles, since the flocking is destroyed by the action of UV radiation after just a very short time.

### SUMMARY OF THE INVENTION

The object of the present invention is therefore to develop further the flocking adhesives pertaining to the state of the art in such a way that said flocking adhesives are also suitable for outdoor applications that are subject to intense exposure to light or UV radiation.

The solution according to the invention that achieves this object consists substantially in the provision of UV-resistant flocking adhesives for polymeric substrates, which are synthesised on the basis of 2-component polyurethane binding agents, the one component being a conversion product of a polyester polyol with an aliphatic or cycloaliphatic polyisocyanate and the other component containing at least one polyamine.

The present invention further provides a process for producing a flocked article, said production process including the following essential process steps:

a) if necessary, the elastomer surface to be flocked is pretreated; this can be done by mechanical roughening, by plasma pretreatment or by solvent treatment (swelling),

b) the flocking adhesive is applied onto the elastomer surface by spray coating, roller coating or brush coating,

c) the flocking material is applied onto the adhesive-coated elastomer surface in a manner known as such by electrostatic flocking,

d) subsequently the drying/curing of the adhesive bond takes place; this can be effected optionally by heating the flocked substrate to temperatures up to 220° C., preferably up to 180° C.

The present invention further provides a flocked article based on an elastomer, in which the flocking material is bonded to the elastomer/moulding with an adhesive according to the invention.

### DETAILED DESCRIPTION OF THE INVENTION

An essential constituent of the binding agent of the flocking adhesive is accordingly a conversion product of a polyester polyol with an aliphatic or cycloaliphatic polyisocyanate.

Suitable polyester polyols can be produced, for example, by polycondensation reaction, polyaddition reaction and/or transesterification reaction of dicarboxylic acids, dicarboxylic anhydrides or dimethyl esters of dicarboxlyic acids with diols or higher polyols or with a mixture of diols and higher polyols. Further polyester polyols can be obtained by ring opening of epoxidised esters, for example epoxidised esters of fatty acids, with alcohols. Polycaprolactone diols, capable of being produced from ε-caprolactone and diols or polyols of higher functionality, are also suitable as polyester polyols. Within the scope of the present invention, polyester polyols, for example, can be employed that can be obtained from low-molecular C3 to C12 dicarboxylic acids such as succinic acid, glutaric acid, adipic acid, sebacic acid, decanedioic acid, dodecanedioic acid, isophthalic acid, terephthalic acid or phthalic acid, or from a mixture of two or more thereof, by conversion with an excess of linear or branched, saturated or unsaturated aliphatic diols with about 2 to about 12 carbon atoms. Examples of such aliphatic diols are 1,2-ethanediol (ethylene glycol), 1,4-butanediol (1,4-butylene glycol), 1,6-hexanediol, 1,8-octanediol, 1,10-decanediol or 2,2-dimethyl-1,3-propanediol (neopentyl glycol). Optionally, a small proportion of polyhydric alcohols can also be used concomitantly in the production of the polyester polyols; such alcohols include, for example, glycerin, trimethylolpropane, triethylolpropane, pentaerythritol or sugar alcohols such as sorbitol, mannitol or glucose. The last-named polyhydric alcohols (alcohols of higher functionality) may also be added to the polyol mixture directly without esterification in the course of production of polyurethane prepolymer. The polyester polyols that are employed have a molecular weight from about 1,000 to about 50,000 and also an OH-value from about 10 to about 200.

In a preferred embodiment, substantially linear polyester polyols that contain carbonate groups and have a molecular weight from about 1,000 to about 50,000 and also an OH-value from about 10 to about 200, preferably about 20 to about 80, are employed for the flocking adhesives according to the invention. Such polyester polyols can be obtained by conversion of phosgene or, alternatively, of aliphatic or aromatic carbonates, such as, for example, diphenyl carbonate or diethyl carbonate, with dihydric or polyhydric alcohols. A concrete example is a polycarbonate based on the conversion of diphenyl carbonate with 1,6-hexanediol. Suitable commercially available polyester polyols are, for example, DESMOPHEN-2020-E, DESMOPHEN-C-200, BAYCOLL-AD-2052 (manufacturer: Bayer AG) or RAVECARB-106 or -107 (manufacturer: Enichem), or mixtures of two or more of these polyester polyols, optionally in a blend with other aforementioned polyester polyols.

Examples of aliphatic or cycloaliphatic polyisocyanates are tetramethoxybutane-1,4-diisocyanate, butane-1,4-diisocyanate, hexane-1,6-diisocyanate (HDI), 1,6-diisocyanato-2,2,4-trimethylhexane, 1,6-diisocyanato-2,4,4-trimethylhexane and also 1,12-dodecane diisocyanate (C12DI), 4,4′-dicylohexylmethane diisocyanate (H12MDI), 1-isocyanatomethyl-3-isocyanato-1,5,5-trimethylcyclohexane (isophorone diisocyanate IPDI), cyclohexane-1,4-diisocyanate, hydrogenated xylylene diisocyanate (H6XDI), 1-methyl-2,4-diisocyanatocyclohexane, m-tetramethylxylene diisocyanate or p-tetramethylxylene diisocyanate (m-TMXDI, p-TMXDI) and dimer fatty-acid diisocyanate.

With a view to acceleration in the course of production of the polyurethane prepolymer or with a view to accelerating the curing of the flocking adhesive, catalysts can be employed that are known as such in polyurethane chemistry. Suitable by way of catalysts that can be employed in accordance with the invention are, e.g., the organometallic compounds of tin, iron, titanium or bismuth, such as tin(II) salts of carboxylic acids, e.g. tin(II) acetate, tin(II) ethylhexoate and tin(II) diethylhexoate. A further class of compounds is represented by the dialkyltin(IV) carboxylates. The carboxylic acids have 2, preferably at least 10, in particular 14 to 32, C atoms. Dicarboxylic acids may also be employed. The following acids may be named explicitly: adipic acid, maleic acid, fumaric acid, malonic acid, succinic acid, pimelic acid, terephthalic acid, phenylacetic acid, benzoic acid, acetic acid, propionic acid and also 2-ethylhexanoic, caprylic, capric, lauric, myristic, palmitic and stearic acid. Concrete compounds are dibutyltin and dioctyltin diacetate, maleate, bis-(2-ethylhexoate), dilaurate, tributyltin acetate, bis(β-methyoxycarbonylethyl)tin dilaurate and bis(β-acetylethyl)tin dilaurate.

Also suitable, in addition, are aliphatic tertiary amines, in particular of cyclic structure. Also suitable amongst the tertiary amines are those which additionally carry groups that react with the isocyanates, in particular hydroxyl and/or amino groups. Concrete examples that may be named are: dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine as well as the ethoxylation and propoxylation products thereof, diazabicyclooctane (DABCO), triethylamine, dimethylbenzylamine (DESMORAPID DB, BAYER), bis-dimethylaminoethyl ether (Catalyst A I, UCC), tetramethylguanidine, bis-dimethylaminomethylphenol, 2-(2-dimethylaminoethoxy)ethanol, 2-dimethylaminoethyl-3-dimethylaminopropyl ether, bis(2-dimethylaminoethyl) ether, N,N-dimethylpiperazine, N-(2-hydroxyethoxyethyl)-2-azanorbornane, or also unsaturated bicyclic amines, e.g. diazabicycloundecene (DBU) as well as TEXACAT DP-914 (Texaco Chemical), N,N,N,N-tetramethylbutane-1,3-diamine, N,N,N,N-tetramethylpropane-1,3-diamine and N,N,N,N-tetramethylhexane-1,6-diamine. The catalysts may also be present in oligomerised or polymerised form, e.g. as N-methylated polyethylene imine. Further preferred catalysts are the derivatives of morpholine such as bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl-4-morpholino)ethyl)amine, tris(2-(2-methyl-4-morpholino)ethyl)amine or tris(2-(2-ethyl-4-morpholino)ethyl)amine, dimethylaminopropylmorpholine, bis(morpholinopropyl)-methylamine, diethylaminopropylmorpholine, bis-(morpholinopropyl)-ethylamine, bis-(morpholinopropyl)-propylamine, morpholinopropylpyrrolidone or N-morpholinopropyl-N′-methylpiperazine, dimorpholinodiethyl ether (DMDEE) or di-2,6-dimethylmorpholinoethyl ether.

The adhesives according to the invention are very frequently sprayed in the form of aerosols, so that it is highly expedient to block the free isocyanate groups of the prepolymer. By way of blocking agents in this connection, use may be made of all blocking agents that are known as such; these include alkylphenols, CH-acidic compounds, imidazoles, aldoximes or ketoximes. The two last-named agents can be produced, as is generally known, by reaction of hydroxylamine with the corresponding aldehydes or ketones. The blocking reaction of the isocyanate groups is preferably effected in this process immediately after production of the corresponding prepolymer. Concrete examples of the oximes to be employed in accordance with the invention are the oxime of butyl aldehyde, of isobutyl aldehyde, of butanone (methyl ethyl ketone) or of 4-methyl-2-pentanone (methyl isobutyl ketone, MIBK).

The second component of the two-component polyurethane binding agent according to the invention contains at least one polyamine. The polyamines can be selected from polyaminoamides based on condensation products of dimer fatty-acid derivatives and aliphatic and/or cycloaliphatic diamines; moreover, use may be made of polyethylene amines or C2 to C16 alkylenediamines or aziridine compounds or mixtures thereof. Optionally, polyoxyalkylenediamines or polyoxyalkylenetriamines (known under the trade name “JEFFAMINE” available from Huntsman) may also be employed.

The binding agents according to the invention further contain anti-ageing agents in the form of anti-oxidants and, in particular, UV screening agents. Examples of anti-ageing agents to be employed are the standard commercial sterically hindered phenols and/or thioethers and/or substituted benzotriazoles and/or amines of the “HALS” type (Hindered Amine Light Stabilizer). It can be useful, in addition, to employ hydrolysis stabilisers, e.g. of the carbodiimide type.

With a view to better wetting and better flow of the adhesive composition on the substrate surface to be flocked, the adhesive formulations may also contain small quantities of surface-active substances or wetting aids; the latter may be, for example, standard commercial mixtures of surface-active polymers.

In principle, the two-component flocking-adhesive compositions according to the invention may be produced and used in solvent-free manner, but for a simpler application it has proved favourable for the two components to be solvent-containing, in which case they may contain either a single solvent or a mixture of solvents. Suitable by way of solvents in this connection are all the solvents that are customary in lacquer technology or adhesive technology; it is preferably a question in this case of aprotic solvents. These may be ketones, e.g. methyl ethyl ketone, methyl isobutyl ketone (MIBK), methyl n-amyl ketone, ethyl amyl ketone, acetylacetone alcohol or diacetone alcohol. Moreover, aromatic hydrocarbons such as xylene, toluene or mixtures thereof may also be employed, as well as aliphatic hydrocarbon mixtures with boiling points between about 80° C. and 180° C. Further suitable solvents are, for example, esters such as ethyl acetate, n-butyl acetate, isobutyl isobutyrate or alkoxyalkyl acetates such as methoxypropyl acetate or 2-ethoxyethyl acetate. It may be expedient to employ mixtures of the aforementioned solvents.

Component A, i.e. the (blocked) polyurethane prepolymer, conventionally contains 0 to about 60 wt. % solvent, preferably 10 to 45 wt. %. The polyamines-containing component B may contain 0 to 75 wt. %, preferably 20 to 70 wt. %, solvent. For the production of the polyurethane prepolymer, in the first stage an NCO:OH ratio from 1.5:1 to 4:1 is chosen; the ratio is preferably 1.8 to 2.5:1. In the subsequent blocking reaction the free isocyanate groups that are still present are totally converted with the blocking agent.

The mixing ratio of the blocked urethane component A to the amine-type component B can be adapted within wide limits to the practical requirements; it depends on the solids content of the two components A and B and also on the content of reactive blocked isocyanate groups in component A to the amine equivalents in component B. Preferred is a ratio of components A:B such as 1:1 to 5:1; a ratio of 3:1 is particularly preferred.

The invention will be represented in the following on the basis of a number of examples, whereby the selection of the examples is not intended to constitute any limitation of the scope of the subject-matter of the invention; they show, in exemplary manner only, the mode of action of the flocking adhesives to be employed in accordance with the invention. The quantities stated in the examples are parts by weight, unless otherwise stated.

### EXAMPLES

### Example 1

An NCO-terminated prepolymer was produced from the following constituents:

34.00 polycarbonate polyester polyol (linear, aliphatic), DESMOPHEN C 200, Bayer;

0.67 trimethylolpropane (TMP), Perstorp;

12.00 dicyclohexylmethane diisocyanate, DESMODUR W, Bayer;

0.04 dibutyltin dilaurate, TINSTAB-BL 277, Akcros (Akzo);

16.63 xylene;

3.33 methoxypropyl acetate;

4.07 methyl ethyl ketoximebutanone oxime

The reaction was carried out until the NCO content was constant, then 4.07 parts of methyl ethyl ketoxime (butanone oxime) were added for the purpose of blocking the free isocyanate groups. Subsequently the following constituents were added to the prepared formulation of component A:

16.63 toluene;

11.73 4-methylpentanone-2 (MIBK);

0.40 mixture of butyl-4-hydroxy-5-(2-benzotriazolyl)-phenylpropionic acid and polyglycol ester, TINUVIN 1130, Ciba Geigy;

0.40 decanedioic acid-bis-4(1,2,2,6,6-pentamethylpiperidinyl)ester; bis-(1,2,2,6,6-(pentamethyl-4-piperidyl)-sebacate, TINUVIN 765, Ciba Geigy;

0.10 mixture of surface-active polymers, BLISTER FREE 3, Schwegmann

### Example 2

The curing-agent component B was produced from the following constituents by mixing:

REAMMIDE 115 X 70, 20.00 Wt. %, polyaminoamide 70-% solution in xylene, Henkel (Chemplast);

VERSAMINE I 756, 5.00 Wt. %, polyethylene amine/alkylphenol solution, Henkel (Chemplast);

CROSSLINKER CX 100 4.00 Wt. %, trimethylolpropane tris(2-methylaziridinyl)propionate, Zeneca;

Ethyl acetate, 20.00 Wt. %;

Toluene, 51.00 Wt. %.

### Example 3

### Suitability Tests of the Flocking Adhesive

EPDM sheets were produced with a rubber mixture S7 available from Draftex and were roughened with sand paper. Immediately after this, the flocking adhesive was mixed from 3 parts of component A from Example 1 and one part of component B from Example 2 and was sprayed onto the EPDM sheets, then a polyester cut flock, black or grey/charcoal, 3.3 dtex/0.7 mm, was sprayed on electrostatically. Subsequently drying/curing took place for 3 min. at 200° C. in a circulating-air oven. The peel strength of the flock was subsequently carried out with the so-called sealing-lacquer test (following the instructions provided by DaimlerChrysler). To this end, strips with a size of about 1×15 cm were cut out of the flocked sheets. A layer of sealing wax 1 cm high and 7 cm long was poured on over the flocked layer and was cooled. The layer of sealing wax was then peeled off from the flocked substrate at an angle of 90° with the aid of a roll. The force that is measured in the process is the measurement of the adhesive strength. Values of 2.0 N/mm are demanded; values of 4.5 N/mm were measured.

The abrasive resistance was carried out with the aid of a rubbing-fastness test; to this end, following a test method that is conventional in the leather industry, an object similar to a chisel, loaded with 500 g, was conducted over the flocked workpiece (frequency 40 min−1); this test is also designated amongst experts as the “VW chisel test”. For a flocked material 250 alternations of load are demanded; for the adhesive according to the invention more than 300 alternations of load were found.

The UV resistance was carried out with a xenon test at 115° C. (temperature of standardized black panel in accelerated UV exposure testing) in accordance with the specifications provided by AUDI. For this, 200 hours of loading capacity are demanded. The substrate that had been flocked in accordance with the invention showed no flock abrasion and only extremely slight discoloration, even after more than 400 hours of the UV test. This shows the high UV resistance of the adhesive bond according to the invention.

This shows that the elastomers that had been flocked in accordance with the invention are outstandingly suitable for outdoor applications with high UV loading.

Adhesives according to the state of the art which are based on polypropylene glycols and aromatic isocyanates in one-component form, and two-component adhesives blocked in the form of butanone oxime, were totally destroyed in the xenon test after just 100 h.

What is claimed is:

1. A UV-resistant flocking adhesive for polymeric substrates comprising a two-component polyurethane binding agent, wherein:
a) a first component of the two-component polyurethane binding agent comprises a conversion product of at least one polyester polyol with at least one polyisocyanate selected from the group consisting of aliphatic and cycloaliphatic polyisocyanates; and
b) a second component of the two-component polyurethane binding agent comprises at least one polyamine.

2. The flocking adhesive according to claim 1, wherein at least one polyester polyol is a largely linear polyester polyol containing carbonate groups.

3. The flocking adhesive according to claim 2, wherein at least one polyfunctional polyol selected from the group consisting of trimethylolpropane, pentaerythritol and glycerin is used concomitantly in addition to the polyester polyol to form the conversion product.

4. The flocking adhesive according to claim 1, wherein at least one polyisocyanate of the first component is selected from the group consisting of tetramethoxybutane-1,4-diisocyanate, butane-1,4-diisocyanate, hexane-1,6-diisocyanate (HDI), 1,6-diisocyanato-2,2,4-trimethylhexane, 1,6-diisocyanato-2,4,4-trimethylhexane, 1,12-dodecane diisocyanate (C12DI), 4,4′-dicyclohexylmethane diisocyanate (H12MDI), 1-isocyanatomethyl-3-isocyanato-1,5,5-trimethylcyclohexane (isophorone diisocyanate IPDI), cyclohexane-1,4-diisocyanate, hydrogenated xylylene diisocyanate (H6XDI), 1-methyl-2,4-diisocyanatocyclohexane, m-tetramethylxylene diisocyanate (m-TMXDI), p-tetramethylxylene diisocyanate (p-TMXDI) and dimer fatty-acid diisocyanates and mixtures thereof.

5. The flocking adhesive according to claim 1, wherein the isocyanate groups of the conversion product are blocked.

6. The flocking adhesive according to claim 5, wherein the isocyanate groups are blocked using at least one blocking agent selected from the group consisting of alkylphenols, CH-acidic compounds, aldoximes, ketoximes and imidazoles.

7. The flocking adhesive according to claim 1, wherein at least one polyamine of the second component is selected from the group consisting of polyaminoamides, polyethylene amines, alkylenediamines, aziridine compounds and mixtures thereof.

8. A flocked article comprising an elastomer and flocking material, wherein the flocking material is bonded to the elastomer with a flocking adhesive comprising a two-component polyurethane binding agent, wherein:
a) a first component of the two-component polyurethane binding agent comprises a conversion product of at least one polyester polyol with at least one polyisocyanate selected from the group consisting of aliphatic and cycloaliphatic polyisocyanates; and
b) a second component of the two-component polyurethane binding agent comprises at least one polyamine.

9. The flocked article of claim 8, wherein at least one polyester polyol is a largely linear polyester polyol containing carbonate groups.

10. The flocked article of claim 8, wherein the isocyanate groups of the conversion product are blocked.

11. The flocked article of claim 10, wherein the isocyanate groups are blocked using at least one blocking agent selected from the group consisting of alkylphenols, CH-acidic compounds, aldoximes, ketoximes and imidazoles.

12. A process for producing a flocked article, comprising the following process steps:
a) application of a flocking adhesive to an elastomer surface by spray coating, roller coating or brush coating; and
b) application of the flocking material to the flocking adhesive applied on the elastomer surface; wherein the flocking adhesive comprises a two-component polyurethane binding agent, wherein:
i) a first component of the two-component polyurethane binding agent comprises a conversion product of at least one polyester polyol with at least one polyisocyanate selected from the group consisting of aliphatic and cycloaliphatic polyisocyanates; and
ii) a second component of the two-component polyurethane binding agent comprises at least one polyamine.

13. The process of claim 12, wherein prior to step (a) the elastomer surface is treated by at least one method selected from mechanical roughening, plasma pre-treatment, or solvent treatment.

14. The process of claim 12, wherein after step (b) the flocked article is heated at a temperature up to 220 degrees C.

15. The process of claim 12, wherein at least one polyester polyol is a largely linear polyester polyol containing carbonate groups.

16. The process of claim 12, wherein the isocyanate groups of the conversion product are blocked.

17. The process of claim 12, wherein at least one polyamine of the second component is selected from the group consisting of polyaminoamides, polyethylene amines, alkylenediamines, aziridine compounds and mixtures thereof.

18. A UV-resistant flocking adhesive for polymeric substrates comprising a two-component polyurethane binding agent, wherein:
a) a first component of the two-component polyurethane binding agent comprises a conversion product of at least one largely linear polyester polyol containing carbonate groups with at least one polyisocyanate selected from the group consisting of aliphatic and cycloaliphatic polyisocyanates, wherein the isocyanate groups of the conversion product are blocked; and
b) a second component of the two-component polyurethane binding agent comprises at least one polyamine selected from the group consisting of polyaminoamides, polyethylene amines, alkylenediamines, aziridine compounds and mixtures thereof.

19. A flocked article comprising an elastomer and flocking material, wherein the flocking material is bonded to the elastomer with the flocking adhesive of claim 18.

20. A process for producing a flocked article, comprising the following process steps:
a) application of the flocking adhesive of claim 18 to an elastomer surface by spray coating, roller coating or brush coating; and
b) application of the flocking material to the flocking adhesive applied on the elastomer surface.
